(19) United States
(12) Patent Application Publication
(10) Pub. No.: US 2007/0237338 A1
(43) Pub. Date: Oct. 11, 2007

(54) Method and apparatus to improve voice quality of cellular calls by noise reduction using a microphone receiving noise and speech from two air pipes

(76) Inventor: Alon Konchitsky, Cupertino, CA (US)

Correspondence Address: PERKINS COIE LLP, P.O. BOX 2168, MENLO PARK, CA, 94026, US

(21) Appl. No.: 11/402,405

(22) Filed: Apr. 11, 2006

(51) Int. Cl. H04R 1/02; H04R 3/00; H04R 1/20

(52) U.S. Cl. 381/91; 381/338; 381/337; 381/122

(57) ABSTRACT

A microphone collects voice sound waves from the user through one end of a pipe. Unwanted background noise is collected through the second end of the pipe. The inputs from the two ends of the pipe retain their acoustic wave format. The background signal is subtracted from the voice signal through acoustic wave destruction. The resulting signal has an increased signal to noise ratio useful for increased voice quality as well as call clarity.

### BACKGROUND OF THE INVENTION

1. Field of the Invention

The invention is directed to a novel technique to reduce or cancel noise in communications systems and devices using a microphone within a communications device acoustically coupled to an environmental (background) noise source and to a voice (voice and background) source exterior to the telephone via two air pipes or channels that provides an increased signal to noise ratio (SNR). The communications system may be but is not limited to a wireless network, cellular mobile communication system, cordless telephones, and wireless telephone of any type, wireless voice over packets, voice over Internet Protocol, and wire line voice over packets system. The present invention also relates to communication system suitable for use in cellular telephones, radio telephones, cordless telephones, personal digital assistance (PDA), laptop computers, voice recording devices, wireless and wire line voice over packets, wireless and wire line voice over Internet protocol (VOIP), computers and in other wireless mobile devices or environments where noise reduction is desired.

2. Background

As experienced by many, background, environmental, or ambient sounds, which will be referred to hereinafter as “noise”, in accordance with the commonly acceptable definition thereof, which is “undesired sound”, is very disturbing. For example, conducting a cellular phone conversation from outdoor telephone booths or from an automobile, bus or other public transport vehicle; or, when using a microphone to broadcast information or voice commentary while outside, such as sports fields or arenas or in new reporting, will often result in a great deal of background noise. Sometimes the caller or user of the telephone or other communications device is not even aware of the degraded voice quality at the receivers end, except, that the receiver keeps asking for the speaker to repeat the spoken information.

Several techniques for noise suppression are known in the art. The first such technique is known as a directional microphone, however, directional microphones suffers from the obvious disadvantage of not being able to provide a satisfactory solution to sound received from directions other than the preset (usually two), very distinct directions.

Another known noise canceling technique utilizes electronic generation of “anti-noise” signals precisely out of phase with the incoming noise signals. This technique involves digital processing of sound signals and the irradiation of noise signals into space, out of phase with the phase of the incoming noise signals, so as to cancel out only the incoming noise signals. The use of this method requires the use of expensive digital processing circuitry and adds size and bulk to the system. These systems and methods and their associated digital processing circuitry and algorithms also consume considerable electrical power or energy and therefore are not entirely suitable for small portable battery powered devices such as cellular telephones, PDAs, or the like.

A more common noise cancellation technique employs several individual microphones placed in spaced-apart relationship producing output signals corresponding to the sound picked up by the several microphones, which signals are then processed and delayed in different ways to obtain an improved signal-to-noise ratio. This technique requires additional components, expense and complexity.

Other techniques, such as digital signal processing techniques to reduce noise are also known in the related art. For example, U.S. Pat. No. 6,415,034 (the “Hietanen patent”) describes a second background noise microphone located within an earphone unit or behind an ear capsule. Digital signal processing is used to create a noise canceling signal which enters the speech microphone. Unfortunately, the effectiveness of the method disclosed in the Hietanen patent is compromised by acoustical leakage, that is where ambient or environmental noise leaks past the ear capsule and into the speech microphone, so that the noise removal is not entirely effective. The Hietanen patent also relies upon expensive digital circuitry and processing power and the requirements for additional power or energy consumption, all of which are limiting factors in portable battery powered mobile communications.

U.S. Pat. No. 5,969,838 (the “Paritsky patent”) discloses a noise reduction system utilizing two fiber optic microphones that are placed side-by-side to one another. Unfortunately, the Paritsky patent discloses a system using light guides and other relatively expensive and/or fragile components that are not entirely suitable for the rigors of cellular phones and other mobile communication or recording devices.

Therefore, there is a need in the art for a method of noise reduction that is robust, suitable for mobile use, low power consuming, and inexpensive to manufacture.

### SUMMARY

The present invention overcomes shortfalls in the related art by using a microphone covered by or coupled with a structure of two pipes, or air tunnels, that are positioned on a device to collect primarily a voice or speech input (that may also include a noise component) and background noise (that may also include a voice component). One pipe (or the entrance aperture to one pipe) is directed or headed towards the speakers mouth or placed in a position so that it collects primarily the speaker's speech, while the other pipe (or an entrance aperture to the other pipe) is directed in a different direction that may be up to 180 degrees from the first pipe. The second pipe or entrance aperture to the second pipe is positioned and/or directed to primarily collect the background noise though it may also collect some of the speakers voice. Typically the other pipe will be in a direction that that will collect the ambient or background noises or sounds and be directed away from the direction of the user's speech, and although they may be directed at various directions to accomplish this, they may typically be from 30 to 180 degrees relative to the first pipe direction, more usually from about 90 degrees to 180 degrees, and even more usually from about ±120 degrees to about ±180 degrees. The angle itself is not so important as is the placement of the two entrance apertures so as to collect primarily voice in the first pipe and primarily background or ambient noise or sounds other than voice in the other entrance aperture. The pipes, tubes, conduits, or other channels to direct and communicate the sound or acoustical waves toward the microphone or other sound transducer are rugged and inexpensive to manufacture and could be manufactured as a basic cover that has two pipes, or two holes in it. The pipes may be formed as individual pipes, tubes, or other acoustic conduits, or they may be formed integral to the device housing or internal components so that the desired pipes or tubes are formed after assembly. In some embodiments, the pipes may simply be void spaces within the interior of the cellular telephone or other communications or recording device. The two pipe cover provides a subtraction function, which removes or reduces the background noise from the voice input which yields a clearer voice signal and a higher signal to noise ratio.

In one aspect, the invention provides a method of noise reduction or noise cancellation comprising the steps of: collecting a speech voice acoustic wave signal from one voice signal air pipe tunnel connected to or coupled with a microphone; collecting a background acoustic wave noise signal from a second background signal air pipe tunnel connected to or coupled with the microphone; and subtracting the background acoustic wave noise signal from the speech voice acoustic wave signal through wave destruction.

In another aspect, the invention provides a noise reducing device comprising: means for detecting background noise; means for detecting a speech signal; and means for subtracting the background noise from the speech signal.

In another aspect, the invention provides a method of increasing the signal to noise ratio of a communication system by noise reduction comprising the steps of: detecting a speech signal from one air pipe tunnel connected to a microphone; detecting background noise from a second air pipe tunnel connected to the microphone; positioning the two air pipe tunnels from each other to create a wave destruction function which subtracts the background noise from the speech voice wave signal.

In another aspect, the invention provides a noise reducing apparatus for use on a device, the apparatus comprising: a transducer for generating a time varying electrical signal in response to a time-varying acoustic pressure wave impinging on the transducer; a first orifice exposed at the surface the device, the first orifice disposed to collect a background acoustic wave impinging on the device at the first orifice and couple the collected background acoustic wave to the transducer through a first pipe extending from the first orifice to the transducer; a second orifice exposed at the surface the device, the second orifice disposed to collect a speech voice acoustic wave impinging on the device at the second orifice and couple the collected speech voice acoustic wave to the transducer through a second pipe extending from the second orifice to the transducer; and a chamber defined proximate the transducer and coupled with terminal portions of the first pipe and the second pipe interior to the device receiving the collected background acoustic wave and the speech voice acoustic wave and generating a resulting acoustic wave proximate the transducer that is the difference of the speech voice acoustic wave and the background acoustic wave.

In another aspect, the invention provides cellular telephone comprising: a housing having at least one exterior surface; a first substantially hollow air pipe opening onto the surface at a first aperture and coupled with a microphone internal to the housing; a second substantially hollow air pipe opening onto the surface at a second aperture positioned away from the first aperture and coupled with the microphone internal to the housing; the first and second air pipes intersecting in a region at or near the microphone and communicating sound waves entering through the first and second apertures for acoustic wave interference to the microphone.

In another aspect, the invention provides a cover for a microphone, the cover comprising: a coupling for abutting or fastening the cover to a microphone or to a housing of a microphone; a chamber adjacent the coupling to provide a volume of air for communicating first and second acoustic waves carrying first and second sound waves; a first pipe coupled at a first end to the chamber and having a second end exposed to the environment and adapted to capture at least a portion of a first set of sounds at a first aperture; and a second pipe coupled at a first end to the chamber and having a second end exposed to the environment and adapted to capture at least a portion of a second set of sounds at a second aperture; the first and second pipes being sized to permit transmission of at least one acoustic sound wave having frequencies in the range between a low frequency and a high frequency.

### BRIEF DESCRIPTION OF THE DRAWINGS

FIG. 1 is an illustration showing typical voice-speech and noise distribution in a normal situation of a phone conversation using a mobile communications device such as a cellular telephone.

FIG. 2 is a front view of a telephone constructed in accordance with the an embodiment of the disclosed invention.

FIG. 3 is a side view of a telephone constructed in accordance with an embodiment of the disclosed invention with two entrance apertures coupled with air tunnels, tubes or pipes, on the front side and the rear side of the telephone.

FIG. 4 is an illustration showing an exemplary drawing of two single-frequency sinusoidal in-phase waves and mathematical function of the wave constructive interference mechanism showing wave reinforcement applicable to wave interference of the air pipes connected to the speech and background noise pipe-tunnels acoustically coupled to a microphone.

FIG. 5 is an illustration showing an exemplary drawing of two single-frequency sinusoidal out-of-phase waves and mathematical function of the wave destructive interference mechanism showing wave cancellation applicable to wave interference of the air pipes connected to the speech and background noise pipe-tunnels acoustically coupled to a microphone.

FIG. 6 is an illustration of an exemplary embodiment of two air tunnels or pipes connected together and operable to direct the primarily background sound waves and the primarily voice sound waves a regions of space at the microphone where the two sound waves can interfere (constructively and destructively) for background noise cancellation to generate a noise reduced or cancelled enhanced voice signal which the microphone detects in accordance with embodiments of the disclosed invention.

FIG. 7 is an illustration showing a partial sectional view of the embodiment of the pipe assembly of FIG. 6.

FIG. 8 is an illustration showing an additional embodiment of the invention wherein a first voice signal aperture is exposed and opens onto the front surface of the cellular phone and a second background signal aperture is exposed and opens onto the side surface of the cellular phone away from where the user would speak.

In FIG. 9 is an illustration showing an additional alternative embodiment wherein the first and second aperture and first and second pipe are more symmetrical and shorter.

FIG. 10 is an illustration showing yet another embodiment of the invention having a front side placement of the voice aperture and a back side placement of the background aperture.

FIG. 11 illustrates in schematic fashion portions of a conventional cellular telephone.

FIG. 12 is an illustration showing how the inventive device and method may be used in conjunction with an otherwise conventional voice communication or recording device of FIG. 11.

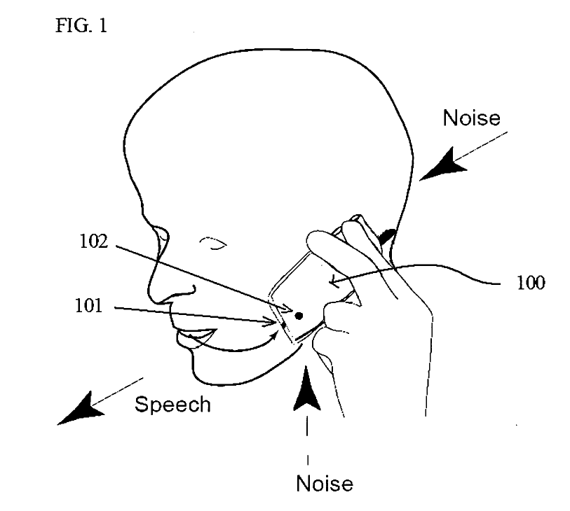

### DETAILED DESCRIPTION OF EMBODIMENTS OF THE INVENTION

This invention may be used with or applied to any communications or recording device that has a microphone to transducer acoustic or sound wave signals into electrical signals, such as but not limited to wired and wireless telephones of any type and recording devices. It is particularly applicable when attempting to communicate a user's voice or speech signal over a communications channel to a receiver, including either another device or a human receiver or listener. Particular applications include cellular telephones, wireless telephones and/or cordless telephones, such as may be used inside a residential home or office, radio transceivers and so called waki-talkie devices, voice-over internet telephones, voice over network packet, and cellular or other wired or wireless mobile or fixed telephones or other communication devices. The invention may also be applied to non-voice signals that are generated or captured in the presence of ambient or environmental noise.

Cellular telephones are a particularly important though not the only application. Cellular telephones now described but it will be appreciated in light of the description provided here that the principles apply to the other devices, networks, and systems as well.

A cellular network is a radio network made up of a number of radio cells (or just cells) each served by a fixed transmitter, normally known as a base station. These cells are used to cover different geographical areas in order to provide radio coverage over a wider geographical area than the area of one cell. Cellular networks are inherently asymmetric with a set of fixed main transceivers each serving a cell and a set of distributed (generally, but not always, mobile) transceivers which provide services to the network's users.

The primary requirement for a cellular network is that the each of the distributed stations need to distinguish signals from their own transmitter from the signals from other transmitters. There are two common solutions to this requirement, frequency division multiple access (FDMA) and code division multiple access (CDMA). FDMA works by using a different frequency for each neighboring cell. By tuning to the frequency of a chosen cell, the distributed stations can avoid the signal from other neighbors. The principle of CDMA is more complex, but achieves the same result; the distributed transceivers can select one cell and listen to it. Other available methods of multiplexing such as polarization division multiple access (PDMA) and time division multiple access (TDMA) cannot be used to separate signals from one cell to the next since the effects of both vary with position, making signal separation practically impossible. Orthogonal frequency division multiplex (OFDM) in principal, consists of frequencies orthogonal to each other. Time division multiple access, however, is used in combination with either FDMA or CDMA in a number of systems to give multiple channels within the coverage area of a single cell.

In the case of a typical taxi company, each radio has a selector knob or button. The knob or button acts as a channel selector and allows the radio to tune to different frequencies. As the drivers and their vehicles move around, they change from channel to channel. The drivers know which frequency covers approximately what area, when they don't get a signal from the previously selected transmitter, they may typically also try other channels until they find one which works or on which they are able to receive or monitor communications in their local area. Usually, the taxi drivers only speak one at a time, as invited by the operator or according to voice traffic on the channel, in a sense time division multiplexed system.

Voice over packets, or Voice over IP (Internet protocol) is now described. Voice over Internet Protocol (also called VoIP, voice over internet packets, IP Telephony, Internet telephony, and sometimes Digital IP Phone) is the routing of voice conversations over the Internet or any other Internet protocol (IP)-based network. The voice data flows over a general-purpose packet-switched network, instead of traditional dedicated, circuit-switched voice transmission lines.

Protocols used to carry voice signals over the IP network are commonly referred to as Voice over IP or VoIP protocols.

Voice over IP traffic might be deployed on any IP network, including ones lacking a connection to the rest of the Internet, for instance on a private building-wide or company-wide local area network (LAN).

The wireless world comprises the following exemplary, but not limited communication schemes: time based and code based. In the cellular mobile environment these techniques are named under TDMA (time division multiple access) which comprises but not limited to the following standards GSM, GPRS, EDGE, IS-136, PDC, and the like; and CDMA (code division multiple access) which comprises but not limited to the following standards: CDMA one, IS-95A, IS-95B, CDMA 2000, CDMA 1xEvDv, CDMA 1xEvDo, WCDMA, UMTS, TD-CDMA, TD-SCDMA, OFDM, WiMax, WiFi, and others).

For the code division based standards or orthogonal frequency division, as the number of subscribers grows and average minutes per month increase, more and more mobile calls typically originate and terminate in noisy environments. The background or ambient noise degrades voice quality.

For the time based schemes, like GSM or GPRS or Edge schemes, improving the end-user voice signal-to-noise ratio (SNR), improves the listening experience for users of existing TDMA (time division multiple access) based networks, by improving the received speech quality by employing background noise reduction or cancellation at the sending or transmitting device.

These noise reduction and cancellation improvements also increase the caller satisfaction and the return on investment to the network operator by both attracting more uses to the network because of the public perception of better than competitor quality and permitting the network operator to increase network capacity without additional costly network infrastructure.

By extending the area where calls with acceptable voice quality can be made, the disclosed innovation is particularly effective at cell-edges or transitions between adjacent cells with low or marginal signal conditions.

The present invention is directed toward the design and construction of both an acoustically based method and device for reducing and in some situations canceling ambient or environmental background noise that can be coupled to a conventional microphone, as well as to a method and device that includes a microphone (or other transducer) system that yields an increased voice signal-to-background noise ratio (SNR).

A microphone assembly comprising a microphone transducer coupled with first and second air pipes, captures primarily voice sounds from a first voice pipe placed or directed toward the speaker's mouth and captures background ambient noise from a second background pipe located or directed at an angle different from the first pipe, and usually at an able that is from about 90 degrees up to 180 degrees from the first pipe. In principal, the background or ambient noise collecting pipe may be positioned or directed at any angle (0 to ±180 degrees) relative to the first pipe, but usually best performance is achieved by positioning and/or directing the second pipe so that it collects primarily background or ambient noise or sounds and a minimum of the speakers voice. Likewise the first or voice pipe may be positioned or directed anywhere but offers the best performance when it is placed near and directed toward the speaker's mouth so that the sound pressure from the voice is greatest.

It should be appreciated that when the pipes or other air tunnels or conduits have more than a small length, it is the entrance aperture of the pipes that are exposed on a surface of the cellular phone or other communications or recording device that may determine what sounds or sound waves that are primarily collected into the pipes. The pipes are then effective to transport or direct the collected waves toward the microphone. The manner in which the position and/or direction of the second pipe is advantageously selected is described in greater detail relative to the description of wave interference below. In general, however, background noise entering from the second pipe is summed by wave destruction (or subtracted by wave construction) that creates subtraction of the background noise sound from the sound captured from the voice signal (that also includes the background noise sound) entering from the first pipe. The resulting sound wave after the resulting constructive-destructive interference at or near the microphone transducer has an increased SNR of the voice relative to the noise as compared to the typical single microphone system without the dual air pipes. The increased signal-to-noise ratio is present both in the resulting interfering sound waves at the diaphragm or other detection means of the microphone as well as in the electrical signal generated by the microphone. By comparison, in a conventional single microphone system, such as for example a system with omni directional speech capture as is conventionally used both background noise and the desired voice single contribute to the electrical signal output by the microphone and enter the communication system. In the present invention, the background noise entering the voice single microphone is removed by sound wave interference (primarily background wave destruction that subtracts the background noise captured by the separate air pipe located up to 180 degrees apart so as to minimize the amount of voice signal captured.

It may be appreciated that because of the ability of a designer to place the entrance aperture to the voice pipe close to and directed at the direction from which the speaker's voice is coming from (usually only a an inch or a few centimeters at most), the magnitude, amplitude, or strength of the voice signal is quite high especially as compared to the voice signal component that may also be present in sound waves captured at the background air pipe aperture that is perhaps only a few inches or centimeters away but preferably directed in an entirely different direction so that the acoustic sound pressure of the voice signal at that background pipe aperture will be quite low as compared to that at the voice air pipe aperture.

Embodiments of the invention as further described below may also provide for different tube or pipe lengths, pipe diameters or cross-section shapes, pipe material or surface properties, turns or directional transitions within the cellular telephone or other communications or recording device, or other design features that generate differential attenuation of the voice and background pipe signals, select or deselect particular frequency ranges of the voice and background signals. In particular it may be appreciated in light of the description provided herein that important components of the spoken voice may for many speakers tend to fall in lower frequency ranges than some types of background or environmental noise, such as wind or machine noise. These different frequency ranges may be processed differently by manipulating the design of the pipes (e.g., absolute and relative lengths, material, surface properties, cross-section, path in the telephone, and the like), pipe apertures (location, size, shape, covering if any, and the like), and even the placement of the microphone and the region identified for wave interference to occur and the resulting noise cancelled wave to be captured by the microphone.

In one embodiment of this invention, the wave cancellation is carried acoustically using strategically placed holes or apertures at the surface of the telephone and pipes or other conduits that funnel or direct the acoustic waves entering at these apertures toward an interference region at or near the microphone. This configuration reduces or cancels environmental noise prior to the microphone in conventional cell phones or communication devices so that the conventional microphone (or optionally a microphone specially adapted to transducer the type of acoustic signal presented by the interfering wave signals) never converts the noise component into an electrical microphone output signal, and the noise never enters the electrical or digital processing stream of the device or communication system. This is the noise reduction and/or cancellation device and method using wave interference that consumes no electrical power and results in the microphone transducing or converting the sound pressure or acoustic incident wave and generating an electrical signal as an input to the conventional audio unit and/or combined audio unit and baseband processing unit that has background noise removed.

The principal of operation is generally based on wave physics theory, but the specific implementation and application to background noise cancellation generally and to specific background noise reduction and cancellation in cellular telephones is novel. Sound or speech is an acoustic wave traveling in a volume of air (or other gas or fluid). When two sound waves interact together interference occurs and the result of the interference may generally depend on the characteristics of the interfering waves and the manner in which they interact. Wave interference is the combining of two or more waves to form a composite (or resultant) wave. Two types of interference can result: constructive interference and destructive interference, though in most acoustic wave situations, there will be a combination of both constructive and destructive wave interference that will in combination generate the resulting wave. The general theory of wave interaction and interference is well understood and is not treated in detail here.

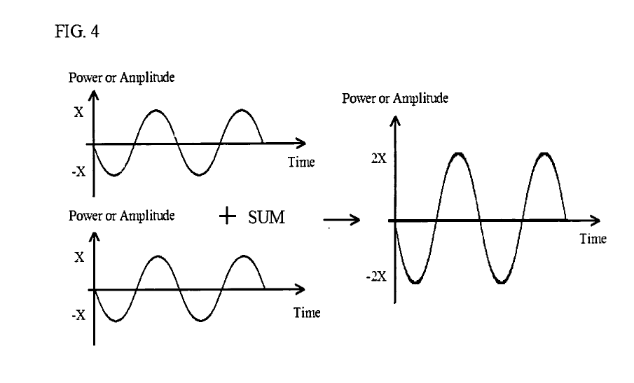

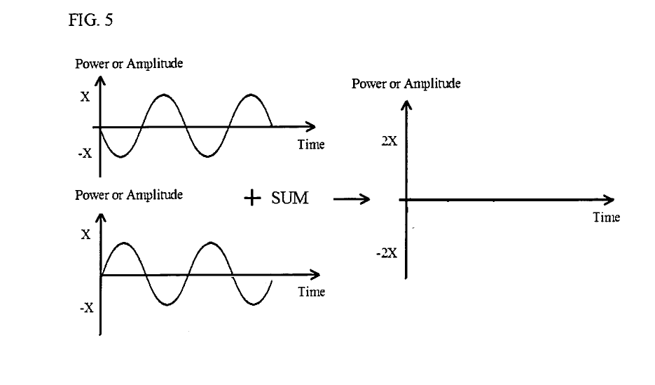

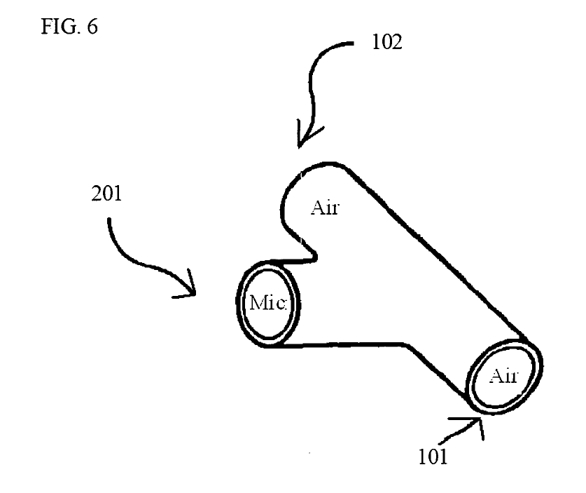

Interfering waves obey the principle of superposition. This means that the displacements of the two or more interfering waves can be added algebraically (sum or subtractive difference) to produce the resultant wave demonstrated in FIG. 4 and FIG. 5 respectively. Although these examples are for single frequency sinusoidal waves that are either precisely in-phase, or precisely 180 degrees out-of-phase, the principle of superposition also applies to waves of different (or multiple frequencies) and at any arbitrary time-shift or phase angle difference. It will also be appreciated that in general, speech signals with added noise will have a substantially more complicated and aperiodic waveform characteristic and that the illustrations in FIG. 4 and FIG. 5 are merely illustrative of the general principles of constructive and destructive wave interference.

The sum type of interference is called constructive interference. Two waves with the same amplitude and which are in-phase with each other. When they arrive simultaneously at the same place, the waves reinforce each other. A larger composite wave results because the amplitudes are added together. The resultant wave will have twice the amplitude of the individual waves, demonstrated in FIG. 4.

The subtractive type of interference is called destructive interference. The same two waves but they are exactly out-of-phase relative to each other. When the crest (point of maximum amplitude) of a wave arrives at a point at the same time as a trough (point of minimum amplitude) of another wave, the two waves tend to cancel each other out. For sinusoidal waves that are 180 degrees out-of-phase, the cancellation is complete. As a result, no output resulting wave is produced and the amplitude and power are zero as demonstrated in FIG. 5.

The mathematics behind this wave interaction phenomenon are now described. The equation for a traveling wave is given by the expression:
y=A sin (kx−ωt) (1)
where k is the wave number, x is the position along the traveling wave, t is time, and ω is the angular frequency. These two values are given by the following formulas, where the function is periodic repeating every 2π radians:

$$k = 2 π and ω = 2 π = 2 π f \\ λ T \qquad ( 2 )$$

where f is the frequency of the wave, λ is the wavelength, and T is the wave period.

Suppose two identical waves were traveling along the x-axis towards each other and produced amplitude displacements of y1 and y2 at a certain point x. We can show the displacements mathematically by rewriting (1) as shown:
y1=y0 sin (kx−ωt) (3)
and
y2=y0 sin (kx−ωt−Φ (4)

where, y0 is the amplitude and Φ is the phase angle difference between the two waves at point x. The resultant displacement y is given by adding equations (3) and (4):
y=y1+y2=y0 sin (kx−ωt)+y0 sin (kx−ωtΦ) (5)

Then use the relation:
sin θ1+sin θ2=2 cos ((θ1−θ2)/2) sin ((θ1+θ2)/2) (6)

Substitute θ1=(kx−ωt) and θ2=(kx−ωt−Φ) to get the expression for resultant displacement:
y=(2y0 cos (Φ/2)) sin (kx−ωt−(Φ/2))
or
y=Am sin (kx−ωt−(Φ/2)) 7)

The resultant amplitude Am=2y0 cos (Φ/2) is not always constant.

For example, suppose that Φ=0° so that there is no phase angle difference. Then cos (Φ/2)=cos 0°=1. Thus, Am=2y0. Therefore, the resultant amplitude is doubled, which is the case when the waves are in-phase with each other.

On the other hand, if Φ=180°, then cos (Φ/2)=cos 90°=0. Thus, Am=0. This is the case where the waves are exactly out of phase.

Therefore, at least for single frequency sinusoidal waves:
cos (Φ/2)=±1 Φ=0, 2π, 4π, 6π, . . . constructive
cos (Φ/2)=0 Φ=π, 3π, 5π, 7π. . . destructive (8)

In order to cancel one signal from the other, using π radians or 180 degrees from each other would eliminate the second wave and therefore reduce noise or interference. These same principles apply to multi-frequency waves wherein the waves, whatever their characteristic, may be seen as being a superposition of many single frequency sinusoidal waves.

Sound sources not equidistant from the microphones experience a phase shift or phase angle difference when they arrive at the microphone. Because sound travels at 1120 ft/sec, the maximum phase shift is a phase shift corresponding to a time of arrival difference for a separation over the difference of about the 6 inches (150 mm) length of a large phone of about 0.5 millisecond. For a more typically sized cellular telephone the maximum possible separation between the primarily voice pipe entrance aperture and the primarily background noise aperture would be on-half to one-quarter this amount or less. Even the 0.5 millisecond difference based phase shift corresponds to about a 90 degrees phase shift at about 1000 Hz and about a 180 degrees phase shift at about 2000 Hz. Thus, choosing a phase difference of about 180 degrees or close to that, i.e. up 180 degrees, will result in cancellation of all or substantially all sounds in the normal human audio frequency range, except the user's voice. Therefore the separation distance between the entrance apertures of the two pipes does not tend to be too critical from the standpoint of phase difference.

The present invention contemplates a myriad of possible alternative microphone configurations and air pipe geometries and configurations. Several exemplary configurations are now described by way of example, and not by way of limitations, so that various aspects of the invention may be more readily understood and appreciated.

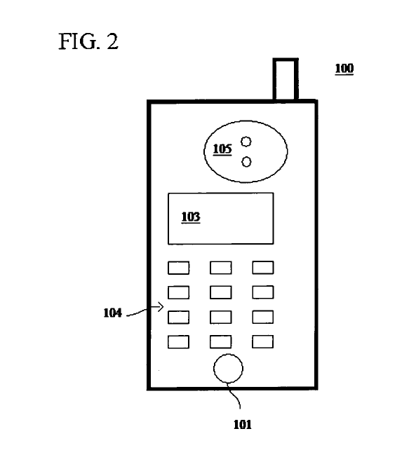

One embodiment of a cellular telephone configuration incorporating the inventive air pipes and microphone with acoustic wave noise cancellation is illustrated in the embodiment of FIG. 2. Handset or phone 100 may for example be a cellular telephone, cordless telephone, wireless telephone, voice over network or internet packet or protocol phone or device, or other communication or voice recording device. In the FIG. 2 embodiment, the phone 100 includes a microphone within the phone acoustically coupled with a structure of two pipes or a pipe assembly including the two pipes. The acoustic coupling of the microphone with the pipes or pipe assembly may be by way of mechanically fitting, attaching, or otherwise fastening a microphone accepting aperture of the pipe in the region of the interference chamber to the microphone as a cover or cap. The first pipe 101 is exposed at the surface of the phone through a first aperture 111 that is directed towards voice (or speech) pipe and acoustically coupled to the interference chamber and microphone within the cellular phone 101 housing. A second aperture 112 also exposed at the surface of the phone and coupled with second air pipe 102 captures background noise, in up to 180 degrees, and acoustically couples this background noise to the same interference chamber and microphone. The interference chamber may simply be a portion of the pipe assembly proximate the microphone where the two waves meet or may be structure having a size, shape, geometry, or other structural or functional property to effect the desired interference and cancellation of the environmental noise while maintaining the voice signal. As illustrated in FIG. 2, the first aperture 111 and first pipe 101 are directed toward the front side of the phone 100 towards the direction of the incoming speech or voice generated by the user, and the second aperture 112 and second pipe 102 are directed outward from the back side of the phone away from the incoming speech or voice so as to capture background noise and only low amplitude speech or voice that may reach the second aperture. For reference, the phone 100 has a typical display 103, keypad 104, and speaker 105.

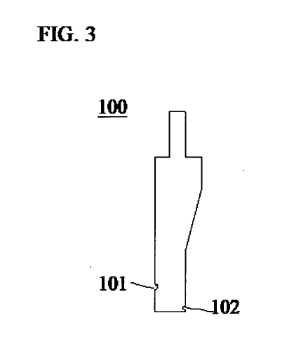

FIG. 3 shows one of the many alternative embodiments with a side view of a typical communication device 100 wherein the voice signal aperture 111 coupled with voice signal pipe 101 is located on the front side of the phone, and the background signal aperture 112 coupled with background signal pipe 102 are located on the rear side of the phone opposite the front side.

FIG. 4 is an illustration showing an exemplary drawing of two single-frequency sinusoidal in-phase waves and mathematical function of the wave constructive interference mechanism showing wave reinforcement applicable to wave interference of the air pipes connected to the speech and background noise pipe-tunnels acoustically coupled to a microphone.

FIG. 5 is an illustration showing an exemplary drawing of two single-frequency sinusoidal out-of-phase waves and mathematical function of the wave destructive interference mechanism showing wave cancellation applicable to wave interference of the air pipes connected to the speech and background noise pipe-tunnels acoustically coupled to a microphone.

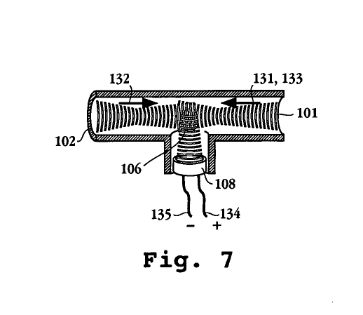

FIG. 6 is a block diagram of an exemplary microphone cover device where background noise entering one pipe 101 in the form of an air movement or air pressure wave, that is located up to 180 degrees from the voice signal pipe 102 that carries the primarily voice air pressure wave. The two pipes are connected together or formed as an integrated single unit creating a summed shape in a region or chamber for wave interference 106, the structure generating an enhanced output wave at 201 such that the background noise input of 101 is removed from the voice signal+background noise input of 102 by wave destruction. The microphone is advantageously attached at or near the interference chamber 106 where it detects the post-interference enhanced wave and generates an electrical signal in response to the detection, the electronic signal being in the form or a voltage, current, or change in resistance, or capacitance with time that represents the enhanced and noise reduced or cancelled wave.

FIG. 7 is an illustration showing a partial sectional view of the embodiment of the pipe assembly of FIG. 6, and particularly showing the transport of the voice 131 and noise 133 acoustic waves (voice+noise) in pipe assembly portion 101 and the transport of the primarily background acoustic noise wave 132 in pipe assembly portion 102. The voice acoustic wave 134 that may be picked up in the background aperture 112 and pipe 102 are not shown to avoid overly complicating the diagram and obscuring aspects of the invention. It also illustrates schematically the interference chamber 106 where the two waves meet and interfere to generate the enhanced sound or acoustic wave from which background noise has been reduced or cancelled leaving a clearer noise-free wave that is picked up by the microphone 108. No attempt has been made in this or the other figures to accurately depict the details of wave interference. Electrical signal outputs 134, 135 of microphone or other transducer 108 are communicated to the communications or recorder device, such as to the analog baseband/voiceband codec input.

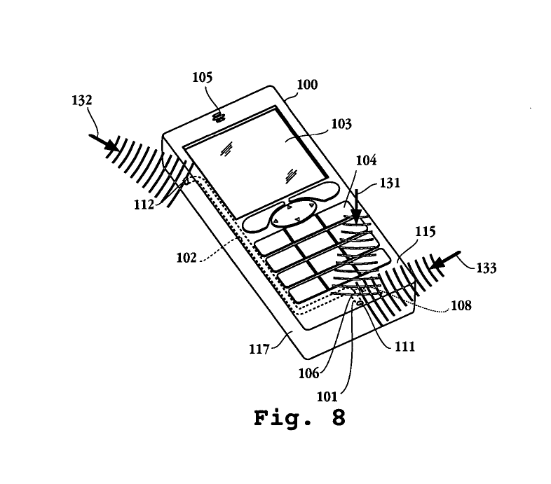

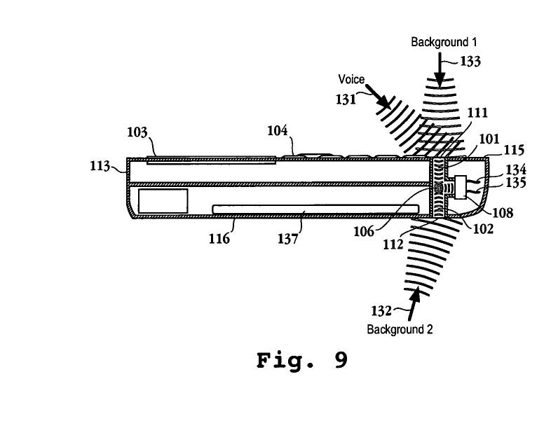

FIG. 8 is illustrated and additional embodiment of the invention wherein a first voice signal aperture 111 is exposed and opens onto the front surface 115 of the cellular phone 100 near where a user or caller would speak and the first voice pipe 101 carries the voice sound wave (and some ambient or environmental noise 133) 131 toward interference chamber 106 proximate microphone 108. Similarly, a second background signal aperture 112 is exposed and opens onto the side surface 117 of the cellular phone 100 preferably away from where the user or caller would speak and the background pipe 102 carries the background sound wave 132 (possibly with a small component of voice speech not shown) toward interference chamber 106 proximate microphone 108. The two waves coming from the first and second pipes interfere and the destructive interference occurring between the two components of the background noise, one background noise component coming from the voice pipe and the other background noise component coming from the background pipe and interfering out of phase to cancel each other. It may be appreciated that the interference chamber may advantageously be placed at particular distances relative to the two apertures and that the lengths of the first and second pipes may be adjusted to optimize the background noise by destructive wave cancellation. The typical location of speaker 105, display 103, and keyboard and keys 104 of the cellular telephone are also illustrated.

In FIG. 9 is illustrated an additional alternative embodiment wherein the first and second aperture 111, 112 and first and second pipe 101, 102 are more symmetrical and shorter than in the embodiment illustrated in FIG. 8. In this embodiment, illustrated as a partial sectional view of a cellular telephone, the voice pipe 101 opens onto a front surface 115 of the cellular phone 100 at voice aperture 111, and the background pipe 102 opens onto a rear surface 116 of the cellular phone 100 at background aperture 112. Some internal components of the cellular telephone, such as circuit board 136 with attached integrated circuit chips 139, battery 137, microphone electrical outputs 134, 135, are also illustrated. As in the other embodiments, an interference chamber 106 located at or near the microphone 108 provides a region for the wave interference and the resulting destructive interference of the out-of phase background noise to cancel before being detected by the microphone 108. A T-shaped pipe assembly such as illustrated in FIG. 6 may be used for this embodiment. This embodiment described herein provides a small and compact implementation of the noise cancellation device. Other embodiments may provide for more of a Y-shaped pipe assembly. In still other embodiments, two pipes may be formed as a continuous single pipe that transmit or funnel the first wave (primarily voice+some noise) and the second wave (primarily noise+some voice) to a region of the single pipe where the microphone is interfaced with or attached to the pipe. The microphone may be flush with the interior surface of the pipe, somewhat recessed toward the outer surface of the pipe, or even extend into the pipe. The location of the microphone effectively defining the location of the chamber where interference occurs so that noise is cancelled by destructive interference of the waves and the resulting clear voice is picked up by the microphone. Each of these embodiments being acoustic in nature, do not consume any electrical power.

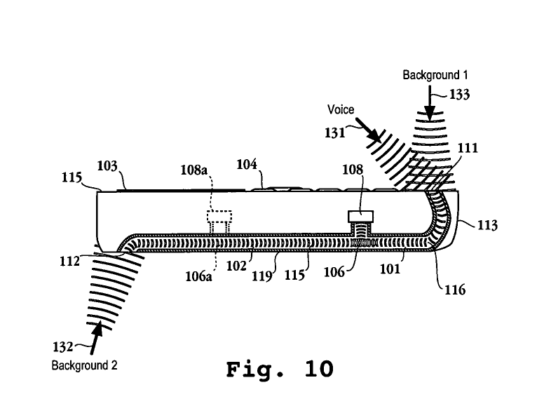

FIG. 10 shows yet another embodiment of the invention having a front side 115 placement of the voice aperture 111 coupling with voice pipe 101 and a back side 119 placement of the background aperture 112 coupling with pipe 102. Voice pipe 101 and background pipe 102 are provided within the cellular phone housing 113 to transport or otherwise communicate the sound pressure acoustic waves 115, 116 to a interference region or chamber 106 at the microphone 108. While the interference region and microphone are shown at one particular location along the pipe assembly, it will be appreciated that the interference region or chamber and microphone should advantageously be placed at a position that will achieve the desired destructive interference and acoustical wave cancellation of the background noise components entering the device via the voice and background apertures. The microphone 108A and interference chamber or volume 106A identify an alternate position to the interference chamber 106 and microphone 108.

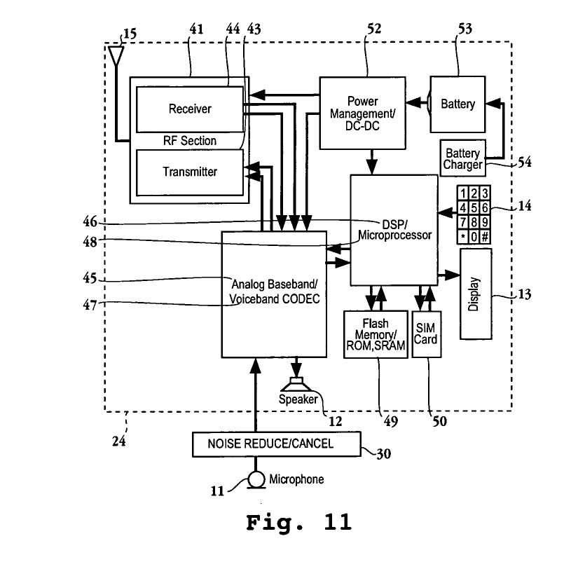

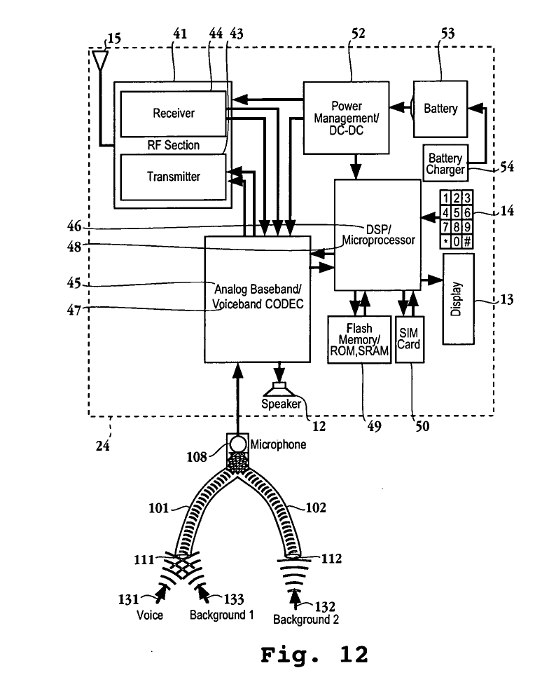

FIG. 11 and FIG. 12 illustrate in schematic fashion how the inventive device and method may be used in conjunction with an otherwise conventional voice communication or recording device. FIG. 11 illustrates the structure of an typical cellular telephone.

Having now described aspects of several embodiments of the inventive acoustic noise reduction and cancellation structure and method, we now describe the relationship of this structure to a conventional cellular telephone architecture to illustrate the relationship between the inventive structure and the analog baseband/voiceband CODEC or other stage of a communications device that normally receives the electrical signal output by the microphone.

FIG. 11 illustrates a typical of the major functional blocks of a cellular telephone of the type not having the noise reduction and cancellation processing of the invention. This architecture is described so that the manner in which the invention interoperates with and improves the performance may be better understood. In particular it will be understood that the invention may be applied to any cellular telephone or communications or voice recording device and complements any other noise reduction devices, processing, or method that the device may already utilize. It may also permit removal or deactivation of some circuit-based techniques that consume electrical power and would no longer be required.

RF section 41 includes a transmit section 42 and a receive section 43 and is where the RF signal is filtered and down-converted to analog baseband signals for the receive signal. It is also where analog baseband signals are filtered and then up-converted and amplified to RF for the transmit signal. Analog Baseband 45 is where analog baseband signals from RF receiver section 44 are filtered, sampled, and digitized before being fed to the Digital Signal Processing (DSP) section 46. It is also where coded speech digital information from the DSP section are sampled and converted to analog baseband signals which are then fed to the RF transmitter section 43. It will be understood that no radio-frequency (RF) section or antenna would be required for a wired line implementation.

The Voiceband Codec (VoCoder) 47 is where voice speech from the microphone 11 is digitized and coded to a certain bit rate (for example, 13 kbps for GSM) using the appropriate coding scheme (balance between perceived quality of the compressed speech and the overall cellular system capacity and cost). It is also where the received voice call binary information are decoded and converted in the speaker or speakerphone 48.

The digital signal processor (DSP) 46 is a highly customized processor designed to perform signal-manipulation calculations at high speed. The microprocessor 48 handles all of the housekeeping chores for the keyboard and display, deals with command and control signaling with the base station and also coordinates the rest of the functions on the board.

The ROM, SRAM, and Flash memory chips 49 provide storage for the phone's operating system and customizable features, such as the phone directory. The SIM card 50 belongs to this category, it stores the subscriber's identification number and other network information.

Power Management/DC-DC converter section 52 regulates from the battery 53 all the voltages required to the different phone sections. Battery charger 54 is responsible for charging the battery and maintaining it in a charged state.

Keypad 55 and display 13 provide an interface between a user and the internal components and operational features of the telephone.

In the FIG. 11 embodiment, microphone 108 provides an electrical signal input to analog base band 45 and/or voice band codec 47. This microphone electrical signal represents the speaker's voice plus any background sound picked up by the microphone.

The embodiment of FIG. 12, shows in simplified manner and not to scale, how the acoustical wave interference based noise reduction and cancellation device interfaces with the conventional microphone (which may generally be relocated within the phone) so as to achieve the non-electronic noise cancellation effects without modifying any of the electrical circuitry within the device. Voice or speech plus a component of environmental noise enters voice pipe 101 through voice pipe aperture 111, while background sound plus a low amplitude version of the voice sound enters background pipe 102 through background aperture 112. The two sound waves mix and interfere in interference chamber resulting in destructive interference of the out-of-phase background noise components. To the extend that any voice signal components may be out of phase, it will be appreciated that the voice wave amplitude or power entering the voice pipe will be much greater than the voice wave amplitude or power entering the background pipe, so that any possible destructive cancellation that may occur between these waves will be inconsequential. Furthermore, it may be appreciated that the inventive acoustical structure and method may be combined with other or existing conventional noise reduction or cancellation techniques which may be implemented within the device.

It will be appreciated that the orifices or apertures (at which the pipes are exposed at a surface of the cellular phone or other device) and the pipes should be sized in diameter or other non-circular cross section and length such that they are able to collect the desired range of acoustic frequencies and communicate them to the microphone (or a chamber or region next to the microphone) so that appropriate frequencies and amplitudes are presented for wave interference. In one embodiment, the frequency range of interest is between about 100 Hz and 3 KHz and the diameters of circular orifices and tubes are selected to be in the 1 mm to 3 mm range. Other embodiments of the invention may use different frequency ranges for either the voice signal or the environmental ambient or background signal and use different sized orifices and/or tubes. Usually the frequency ranges should cover between a low frequency of between about 100 Hz and 300 Hz, while the high frequency range would be selected at between 1000 Hz and 3000 Hz. Other frequency ranges may be used that are higher or lower. The criteria to be used is that the pipes in combination with the entrance aperture or orifice and the chamber where destructive wave cancellation of the background sound occurs should support the voice frequency range of interest for communicating understandable speech and transducing by the microphone. Furthermore, the two pipes should provide for communicating the background or environmental noise to the chamber so that cancellation can occur. In some situations where the length of one pipe is longer or otherwise has a different physical or material characteristic, it may be desirable to alter the other pipe so that an optimum destructive background noise cancellation or reduction may be achieved. Slits, rectangular, oval, or other orifice or tube shapes may alternatively be used. In some embodiments, the tube diameter or cross-section may change between the orifice where the tube is exposed on the surface of the device and the portion or chamber near the microphone where the two tubes emerge and connect. The shapes and diameter of the orifice and tubes for the background signal and for the voice signal may be separately chosen so as to be tuned to achieve either or both of a frequency range selection or amplitude gain/attenuation that is advantageous in achieving the desired wave interference at the microphone. Usually, the tube length between the orifice and the microphone should be as short as possible. In one embodiment, the microphone is placed immediately adjacent to one of the background signal or the voice signal orifices, so that in effect that tube is very short or non-existent and the other tube communicates the signal from the other of the two orifices.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A method of noise reduction or noise cancellation comprising the steps of:
(a) collecting a speech voice acoustic wave signal from one voice signal air pipe tunnel connected to or coupled with a microphone;
(b) collecting a background acoustic wave noise signal from a second background signal air pipe tunnel connected to or coupled with the microphone; and
(c) subtracting the background acoustic wave noise signal from the speech voice acoustic wave signal through wave destruction.

2. The method of claim 1, wherein the background noise signal is collected through a pipe positioned at an angle up to 180 degrees from the angle of the voice signal pipe.

3. The method of claim 2, wherein the two sound inputs retain their acoustic analog format.

4. The method of claim 2, wherein the two pipe openings are configured so as to create the wave destruction function used for subtracting the background noise from the voice input signal.

5. The method of claim 2, wherein the speech signal is detected by the first air pipe tunnel located relatively close to the speaker's mouth and background noise is detected by the second air pipe tunnel located relatively further from the mouth of the speaker.

6. A noise reducing device comprising:
(a) means for detecting background noise;
(b) means for detecting a speech signal; and
(c) means for subtracting the background noise from the speech signal.

7. The device of claim 6, wherein wave destruction is used to subtract the background noise from the speech signal.

8. The device of claim 6, wherein the wave destruction function is created by the relative positions of two input openings, each opening leading to the microphone.

9. A method of increasing the signal to noise ratio of a communication system by noise reduction comprising the steps of:
detecting a speech signal from one air pipe tunnel connected to a microphone;
detecting background noise from a second air pipe tunnel connected to the microphone; and
positioning the two air pipe tunnels from each other to create a wave destruction function which subtracts the background noise from the speech voice wave signal.

10. A method as in claim 9, wherein the positioning of the two air pipe tunnels from each other comprises positioning the two air pipe tunnels up to 180 degrees from each other.

11. A noise reducing apparatus for use on a device, the apparatus comprising:
a transducer for generating a time varying electrical signal in response to a time-varying acoustic pressure wave impinging on the transducer;
a first orifice exposed at the surface the device, the first orifice disposed to collect a background acoustic wave impinging on the device at the first orifice and couple the collected background acoustic wave to the transducer through a first pipe extending from the first orifice to the transducer;
a second orifice exposed at the surface the device, the second orifice disposed to collect a speech voice acoustic wave impinging on the device at the second orifice and couple the collected speech voice acoustic wave to the transducer through a second pipe extending from the second orifice to the transducer; and
a chamber defined proximate the transducer and coupled with terminal portions of the first pipe and the second pipe interior to the device receiving the collected background acoustic wave and the speech voice acoustic wave and generating a resulting acoustic wave proximate the transducer that is the difference of the speech voice acoustic wave and the background acoustic wave.

12. The apparatus of claim 11, wherein:
the first orifice collects primarily a background acoustic wave component and also a speech voice acoustic wave component;
the second orifice collects primarily a speech voice acoustic wave component and also a background acoustic wave component; and
the chamber defined proximate the transducer and coupled with terminal portions of the first pipe and the second pipe interior to the device receiving the collected background acoustic wave and speech voice acoustic wave components from the first pipe and the speech voice acoustic wave and background acoustic wave components from the second pipe, and generating a resulting acoustic wave proximate the transducer that is the difference of the speech voice acoustic wave and the background acoustic wave components collected from each of the first and second orifices.

13. The apparatus of claim 11, wherein the device is a cellular telephone and the first and second orifices are positioned and directed to collect acoustic waves that are substantially 180 degrees ±10 degrees from each other.

14. The apparatus of claim 12, wherein the difference wave destruction function is created by the relative positions of two input openings, each opening leading to the microphone.

15. A communications device comprising:
a housing having at least one exterior surface;
a first substantially hollow air pipe opening onto the surface at a first aperture and coupled with a microphone internal to the housing;
a second substantially hollow air pipe opening onto the surface at a second aperture positioned away from the first aperture and coupled with the microphone internal to the housing; and
the first and second air pipes intersecting in a region at or near the microphone and communicating sound waves entering through the first and second apertures for acoustic wave interference to the microphone.

16. A communications device as in claim 15, wherein the first and second air pipes are formed integral to the housing of the telephone.

17. A communications device as in claim 15, wherein the first and second air pipes sized, shaped, and coupled so that background noise entering the first aperture and first air pipe and entering the second aperture and second air pipe meet at or near the microphone so that they are out of phase and substantially cancel by destructive wave interference.

18. A cover for a microphone, the cover comprising:
a coupling for abutting or fastening the cover to a microphone or to a housing of a microphone;
a chamber adjacent the coupling to provide a volume of air for communicating first and second acoustic waves carrying first and second sound waves;
a first pipe coupled at a first end to the chamber and having a second end exposed to the environment and adapted to capture at least a portion of a first set of sounds at a first aperture; and
a second pipe coupled at a first end to the chamber and having a second end exposed to the environment and adapted to capture at least a portion of a second set of sounds at a second aperture;
the first and second pipes being sized to permit transmission of at least one acoustic sound wave having frequencies in the range between a low speech frequency and a high speech frequency.

19. A cover for a microphone as in claim 18, further comprising the microphone.

20. A cover for a microphone as in claim 18, wherein the low frequency is between substantially 80 Hz and 300 Hz, and the high frequency is between 800 Hz and 3000 Hz.

21. A cover for a microphone as in claim 18, wherein the first and second pipes are substantially hollow.

22. A cover for a microphone as in claim 18, wherein the first and second pipes are made of a material that permits transmission of acoustic sound waves from the first and second entrance apertures to the chamber with less than a predetermined attenuation.

23. A cover for a microphone as in claim 18, wherein the predetermined attenuation is less than 50% attenuation.

24. A cover for a microphone as in claim 18, wherein the predetermined attenuation is less than 25% attenuation.

25. A communications device as in claim 15, wherein the communications device comprises a cellular telephone.

26. A communications device as in claim 15, wherein the communications device comprises a cordless telephone.

27. A communications device as in claim 15, wherein the communications device comprises a radio frequency wireless device.

28. A communications device as in claim 15, wherein the communications device comprises one of a voice over Internet protocol, voice over Internet packets, VOIP, voice over network packet, or combinations of these.

29. A method as in claim 9, wherein the communication system includes a cellular telephone.

30. A method as in claim 9, wherein the communication system includes a cordless telephone.

31. A method as in claim 9, wherein the communication system comprises either a wireless or a wire line or combination of wireless and wire lined communication system or device selected from one of a voice over Internet protocol, voice over Internet packets, VOIP, voice over network packet, or any combinations of these.
